(19) United States
(12) Patent Application Publication
(10) Pub. No.: US 2017/0209869 A1
(43) Pub. Date: Jul. 27, 2017

(54) APPARATUS FOR SEPARATING SOLID MATERIALS

(71) Applicant: AQUAVITRUM LIMITED, Hampshire (GB)

(72) Inventor: Paul Alan ROGERS, Hampshire (GB)

(21) Appl. No.: 15/324,988

(22) PCT Filed: Jul. 14, 2015
(86) PCT No.: PCT/GB2015/052026

§ 371 Date: Jan. 9, 2017

(30) Foreign Application Priority Data
Jul. 15, 2014 (GB) 1412552.0

(51) Int. Cl. B03B 5/40

(52) U.S. Cl. CPC B03B 5/40; B03B 2005/405

(57) ABSTRACT

An apparatus for separating solid materials is described, which comprises a channel for receiving a liquid and the materials to be separated, the channel being provided with an agitation surface. Means for directing streams of fluid at the materials to be separated are provided, the streams of fluid urging the materials over and against the agitation surface to separate the materials. Heavier material is urged along the bottom of the channel to an exit under the action of the streams of fluid, and lighter material separated from the heavier material rises to the surface of the liquid. The agitation surface comprises a plurality of formations each extending across at least a portion of the width of the channel, each formation comprising an ascending surface and a descending surface, at least part of the ascending surface having a steeper slope with respect to the base of the channel than the descending surface. It has been found that the shallower descending surface of one formation followed by the steeper ascending surface of the next formation provides an improvement in agitation of the solid materials as they progress down the descending surface and start to progress up the ascending surface, keeps the transition from the descending surface to the ascending surface clear of a build-up of materials, and provides for the lighter materials to be urged upwards at a suitable angle to reach the surface for removal.

### FIELD OF THE INVENTION

The present invention relates to an apparatus for separating solid materials. Embodiments of the present invention may be applied to the washing of contaminated aggregate material, such as glass cullet, to separate debris from the glass cullet or other aggregate. More particularly, but not exclusively the invention relates to an apparatus for washing glass, particularly broken glass or cullet, and for separating broken glass and cullet from debris and detritus often associated with waste glass and cullet and found in domestic and industrial waste streams. Additionally, this invention relates to the separating and washing of organic material, particularly fibrous organic material, from grit, dirt or other contaminants in order to generate feedstocks for industrial biological processes, including but not limited to biofuel generation.

### BACKGROUND

Waste glass is usually collected at recycling centres, by refuse collection companies and from kerbside crates. The majority of the waste glass originates from containers for foodstuffs and beverages and often the waste glass is contaminated with residual foodstuff and other materials, such as packaging, labels, tops and caps which may be plastics, cork and metal.

Collection is typically by way of large containers, sometimes located below ground level and with options to sort glass into different colours. Other forms of collection are at recycling centres or involve householders/consumers depositing bottles and jars in a container, which may be a kerbside collected bin or container.

Alternative collection systems are silos under walkways with chutes or smaller receptacles adapted to be collected by flat-bed trailers or lorries. However, what is common to all these glass collectors is that glass is often broken due to impact and under weight of glass. Consequently fragments of glass become compacted together.

In some situations where remnants of contents of containers are present, such as foodstuffs, agglomeration of compacted glass, biomaterial (such as food remnant), paper and other container parts (such as lids and packaging) forms into a relatively dense, solid block of waste.

### PRIOR ART

U.S. Pat. No. 8,146,841 (Glass Processing Solutions LLC) discloses a system for cleaning glass particles produced from post-consumer mixed glass and like waste streams. The system operates by way of a series of pulverizing, size separators and material-based separation.

The system also includes ozonation, drying, sizing, and paper/fluff removal steps. The system described is complex and to a degree relies upon a supply of relatively clean raw materials rather than heavily contaminated waste.

UK Patent Application GB-A-563 754 (Ridley) discloses a system for separating solid granular materials, such as coal or mineral ores. The solids settle on a moving surface disposed beneath floating debris at a depth sufficient for separation to take place. The moving surface raises the solids by an upward inclination of the surface.

German Offenlegungschrift DE-A-3 717 839 (Andritz) relates to a system for separating light materials, in particular plastics, from pre-sorted refuse fractions. The mixture is subjected to gravity separation in a sink-float basin and the lighter material is removed by floating off these off, so that the mixture is acted upon by liquid jets. A number of jet nozzles are arranged above the sink-float basin so that liquid jets can be sprayed onto the substrate mixtures.

U.S. Pat. No. 4,844,106 (Hunter) relates to an apparatus for cleaning shards of debris for recycling. The apparatus includes a reservoir containing a washing fluid and a moving conveyor partially submerged. A screen has an outlet positioned above the submerged portion of the conveyor so that the shards pass along the screen to the conveyor while some debris and contaminant material falls through the screen and into the reservoir away from the conveyor. Shards are washed and conveyed past a bank of spray nozzles which spray the shards in a direction against the motion of the conveyor.

Published Chinese Patent Application 2013-A-2013/57110 (China Bluestar) relates to a device for separating mercury from glass fragments in waste fluorescent tube fragments. A spiral conveyor consists of a shell body and a built-in rotating spiral body. The front lower part of the shell body houses a conveyor forming a feed inlet. A mercury discharge opening receives mercury fumes and a spray device is arranged on the front face of a middle region of the shell body.

Whilst to some degree the aforementioned systems have proved effective at their specific intended tasks, there is not any system that is able to remove packaging and labelling from waste glass, such as jars and bottles.

Increasingly there is a demand for clean waste glass as a raw material for many types of specialised end uses, such as producing glass fibre for fireboards or insulating materials.

The present invention arose in order to provide a separator for waste glass specifically adapted to remove residual foodstuff, packaging and contaminating materials from the waste glass. However, it has been recognized that the present invention can also be applied more generally to separating heavier solids from lighter solids. In particular, while the lighter solids may often be waste products, in some cases the lighter solids may have useful purposes in their own right, for example as a biofuel.

Some embodiments of the present invention seek to provide a method of washing glass in order to provide a clean cullet material for processing and other product streams. Embodiments of the invention seek to provide a method of washing and separating debris and waste material from contaminated aggregate, such as, for example glass cullet.

### SUMMARY OF THE INVENTION

According to an aspect of the present invention there is provided an apparatus for separating solid materials, the apparatus comprising:

a channel for receiving a liquid and the materials to be separated, the channel being provided with an agitation surface;

means for directing streams of fluid at the materials to be separated, the streams of fluid urging the materials over and against the agitation surface to separate the materials;

wherein heavier material is urged along the bottom of the channel to an exit under the action of the streams of fluid, and lighter material separated from the heavier material rises to the surface of the liquid; and

wherein the agitation surface comprises a plurality of formations each extending across at least a portion of the width of the channel, each formation comprising an ascending surface and a descending surface, at least part of the ascending surface having a steeper slope with respect to the base of the channel than the descending surface.

It has been found that the shallower descending surface of one formation followed by the steeper ascending surface of the next formation provides an improvement in agitation of the solid materials as they progress down the descending surface and start to progress up the ascending surface, keeps the transition from the descending surface to the ascending surface clear of a build-up of materials, and provides for the lighter materials to be urged upwards at a suitable angle to reach the surface for removal.

The ascending surface may comprise a first ascending part at a first angle with respect to the base of the channel and a second ascending part at a second angle with respect to the base of the channel, the first angle being shallower than the second angle, wherein at least some of the streams of fluid are directed approximately towards the first ascending part. Advantageously, the shallower first ascending part forms a more gradual transition from the descending surface of the previous formation, improving the movement of the aggregate and reducing build-up of materials at the transition from descending surface to ascending surface. The steeper second part sets a suitable angle of upward ascent for the lighter material to reach the surface of the liquid.

The descending surface may extend from an apex of the ascending surface to the base of the ascending surface of an adjacent formation. Preferably, at least some of the streams of fluid are directed approximately parallel with or at a shallow angle down onto the descending surface. This causes the materials to progress down the descending surface and be agitated together to promote separation.

In some embodiments, the second ascending surface may be substantially upright.

In some embodiments, at least part of the ascending surface and/or descending surface is curved and/or concave. Curved surfaces have been found to be less prone to wear, and to permit the materials to progress more smoothly down the channel.

The means for directing may comprise a bank of jet nozzles provided at spaced intervals across the width of the channel, and a deflector extending across the channel in front of the bank of jet nozzles for redirecting and shaping streams of fluid emitted from the jet nozzles to form the streams of fluid directed towards the materials. The deflector may be adjustably attached at either side of the channel and comprise a deflector plate positioned in front of each of the jet nozzles. Such a single-part deflector can be adjusted once for all nozzles in a particular row, and is simpler and cheaper to manufacture and install.

The channel may be provided with an adjustable rim along the upper edge of at least one side of the channel. The inclination of the rim with respect to the channel may be adjustable. Preferably, an adjustable rim is provided along both sides of the channel. When properly configured, preferably the surface of the liquid in the channel is substantially parallel with the upper edge of the rim. A gutter may be provided, which extends along the outside of the channel, to receive liquid escaping from the channel over the rim. Providing an adjustable rim allows the liquid to escape evenly over the rim along the full length of the channel, by adjusting its height (potentially at different heights along its length) to match the surface of the water, which may change depending on flow conditions within the channel.

The channel may be provided with one or more guides at the liquid surface, the guides being shaped to direct separated lighter material at or near the surface of the liquid towards and over the rim and into the gutter. Means, in the form of a bank of water jets and optionally deflectors, may be provided for directing fluid towards the guides and/or the surface of the liquid. The guides may act as a deflector to redirect and shape streams of fluid emitted from jet nozzles to form the streams of fluid directed towards the surface of the liquid, reducing the requirement for separate deflectors. The debris guide may extend below the surface of the liquid, and be sloped such that a prevailing flow of the liquid near the liquid surface pushes the separated lighter material within the liquid against and up the slope of the guide towards the liquid surface. Preferably, the debris guide extends above the surface of the liquid. Generally, the debris guide is configured in the above manner to maximise, as far as possible, the amount of debris which is directed out of the channel and into the gutter.

In some embodiments, when the apparatus is in use, the prevailing direction of the surface current at the top of the channel is substantially opposite to the direction of travel of the heavier material along the bottom of the channel. This may be beneficial, since it tends to result in the water at the exit end of the channel being cleaner than the water at the entrance end of the channel, meaning that the heavier material is generally cleaner when it exits the apparatus.

In some embodiments, the means for directing is integral with and/or part of the agitation surface. For example, the means for directing may be positioned underneath the apex of a formation. With this arrangement, the jets (with deflectors) do not interfere with the upwards movement of the lighter materials, and they also clear the channel of obstructions which might result in complex and undesirable flow patterns within the channel.

In one example, a first, upper, part of the descending surface is defined by the top of a cover under which the means for directing is located, the means for directing being configured to direct the streams of fluid down and along a second, lower part of the descending surface towards the base of the ascending surface of an adjacent formation.

The ascending surface and/or descending surface may have a shallower gradient at or near the base and/or the apex than half way along.

While the apparatus can be used generally to separate any solid materials into a heavier component and a lighter component, the apparatus is particularly beneficial where the heavier material is an aggregate such as glass cullet, and the lighter material is debris. It should be understood however that the debris may itself have a commercial value when separated from the aggregate, for example as a biofuel. More generally, two solid materials may be worthless when combined (input state to the apparatus) but of value when separated (output state from the apparatus).

It may be preferable for a portion of the lighter material to be denser than the fluid. In this embodiment, the apparatus for separating solid materials is particularly beneficial as it enables the separation of materials that are similar in density, typically a significant challenge in the recycling industry. Such an embodiment may be useful in separating glass and dense plastics, although the separation of other mixtures containing an organic waste stream, a lighter than fluid waste stream, a denser than fluid, lighter than glass stream and a glass waste stream denser than all the others is also envisaged. It is also envisaged that the glass waste stream may alternatively be a mineral or ceramic waste stream, or a combination of these waste streams.

It may also be preferable for a turbulent zone to be formed in the fluid proximal to the agitation surface. A turbulent zone may facilitate the mixing, movement or turnover of the heavier and lighter materials, potentially allowing them to be separated by the fluid stream. The turbulent zone may then assist the separation of the lighter and heavier material, the heavier material moving over the formation whilst the lighter material moves to the surface under the influence of the fluid flow.

Preferably, differences between the average shape of the heavier material and the average shape of the lighter material may assist the separation of said materials in the turbulent zone. Such an embodiment may be desirable as there may be differences in the average size or shape of the heavier and lighter materials in a contaminated aggregate, and such a feature will increase the ability of the apparatus to separate these materials.

In such an embodiment, variations in the size,shape and orientation of the materials, along with differences in their density, will cause them to behave differently in the area of turbulence through known impact on the particle Stokes Number (A. Karnik J. S. Shrimpton Phys. Fluids, 2012, 24, 073301). The final result of these differences in behaviour may then be the lighter material moving to the surface of the fluid whilst the heavier material moves over the formation, both under the influence of the fluid flow.

It may also be preferable for the apparatus to further comprise at least one flow divider. Such an embodiment of the invention may be advantageous as it may allow the separation of the turbulent flow at the base of the channel from the more linear, less turbulent, reverse flow in the upper levels of the channel. Separation of these flows may be advantageous as it may allow the rapid removal of any debris, raised to the surface of the water under the influence of the jets and deflectors, from the channel without said debris sinking back into the zone of turbulent flow.

Preferably, said flow divider may be located proximal to the surface of the fluid. Such a feature may be advantageous as the location of said flow divider proximal to the surface of the fluid may allow the most effective separation of the turbulent and less turbulent flows, and thus the most effective removal of any debris raised into the area of less turbulent flow. More preferably, said flow divider is located between 5 mm and 50 mm from the fluid surface, still more preferably between 50 mm and 300 mm from the fluid surface and most preferably at 200 mm from the fluid surface. It may also be preferable for the flow barriers to be moveable such that their position relative to surface of the fluid may be varied.

Preferably, said flow divider may be rotated. More preferably, this rotation is around an axis perpendicular to the longitudinal axis of the channel. Such a rotation may be preferable as it allows the flow divider to be rotated such that the turbulent and less turbulent regions of the flow may be most effectively separated, and any debris raised into the less turbulent region of flow to be rapidly removed from the channel.

Preferably, said flow divider may be moved along the longitudinal axis of the channel. Such a movement may be preferable as it allows the flow divider to be positioned such that the turbulent and less turbulent regions of the flow may be most effectively separated, and any debris raised into the less turbulent region of flow to be rapidly removed from the channel.

Preferably, the liquid (in the channel) and the fluid (streams directed within the channel) are both water. However, in principle a liquid other than water could be used, or the water could have a cleaning additive in it, and the fluid could be different from the liquid, and could potentially be gaseous (e.g. air blades).

Embodiments of the invention will now be described by way of example only and with reference to the following Figures, in which:

### BRIEF DESCRIPTION OF THE DRAWINGS

FIG. 1 schematically illustrates a material separation apparatus according to an embodiment of the present invention;

FIGS. 2A and 2B schematically illustrate an entry chute for a material separation apparatus;

FIGS. 3A and 3B schematically illustrate an exit chute of a material separation apparatus;

FIGS. 4A to 4C schematically illustrate a separation channel;

FIG. 5 schematically illustrates a single part deflector;

FIGS. 6A and 6B schematically illustrate a gutter and adjustable rim;

FIGS. 7A and 7B schematically illustrate a debris guide;

FIG. 8 schematically illustrates a material separation apparatus according to another embodiment of the present invention;

FIG. 9A schematically illustrates a debris guide and water flow associated with the apparatus of FIG. 8;

FIG. 9B schematically illustrates a water flow and area of turbulence associated with the apparatus of 8, omitting the optional debris barrier.

FIGS. 10A to 10E schematically illustrate several agitation surfaces which can be utilised by various embodiments of the present invention; and

FIG. 11 schematically illustrates example (non-limiting) dimensions and structure for the apparatus of FIG. 8.

FIG. 12 schematically illustrates the use of flow dividers or hydrofoils in an aggregate cleaning apparatus.

### DETAILED DESCRIPTION OF PREFERRED EMBODIMENTS OF THE INVENTION

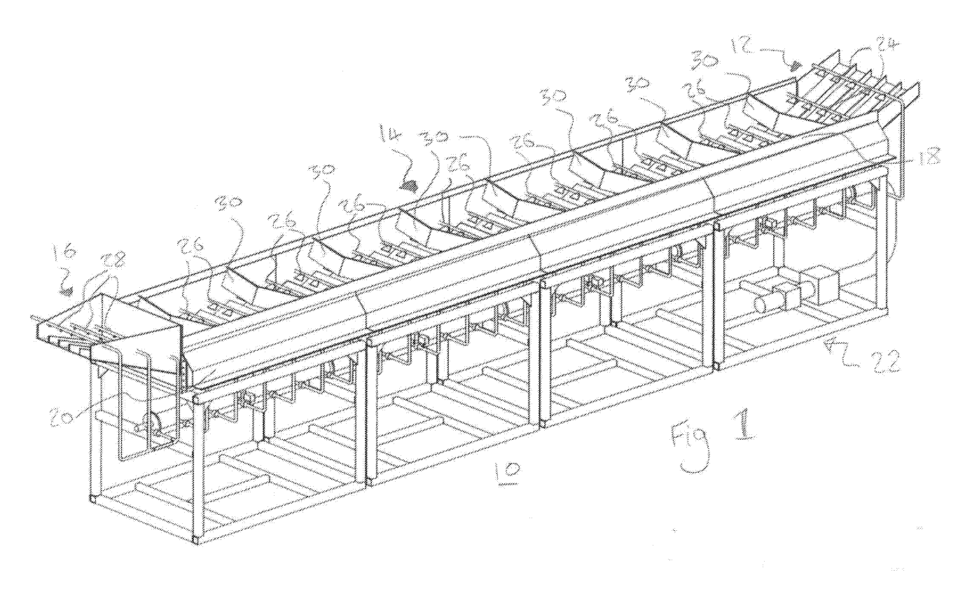

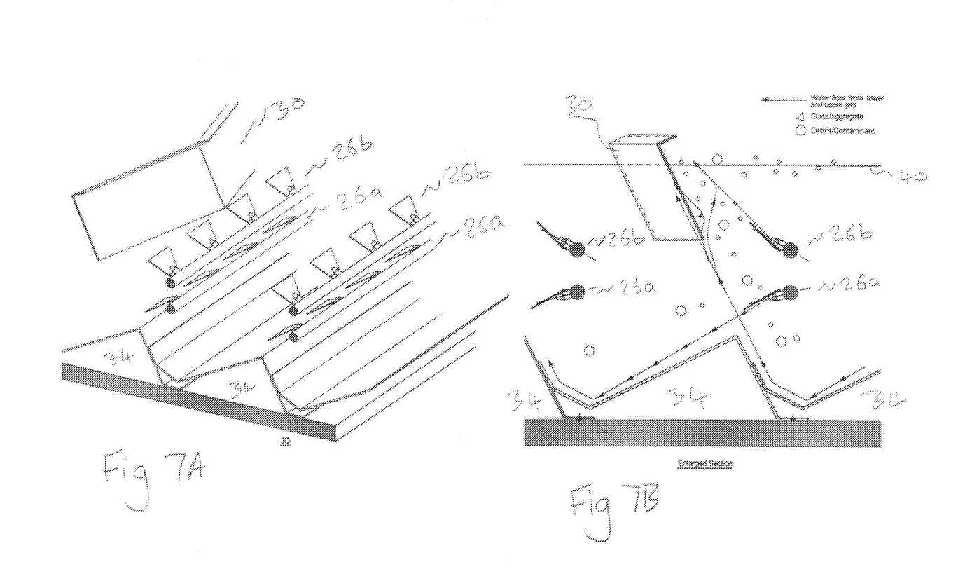

Referring to FIG. 1, an example separation apparatus 10 is shown to comprise an entry chute 12, a separation channel 14 and an exit chute 16. In use, the separation channel 14 is filled to the brim with water (or another liquid). Water, and consequently materials to be separated, move within the channel under the action of a pump, which drives jets of water through the channel, as will be described in detail below. The channel 14 may be a trough, and may have a generally rectangular shape. A rim 18 is provided along the top of each side of the separation channel 14, and in use the water level within the channel 14 reaches slightly above the upper edge of this rim 18, such that water flows out over the rim 18 along the length of the channel 14 into a gutter 20, which extends along either side of the channel 14, to the outside and beneath the rim 18. Preferably, the inside upper edge of the rim has a substantially square (90°) edge, which has been found to promote a better and more controlled flow of fluid over the rim than would be the case for a more rounded or roll-top edge (over which water would flow too readily). Note that only a part of the gutter 20 is shown in FIG. 1, for clarity, but that the shape of the gutter 20 can be seen more clearly in FIG. 6, described in detail below. The debris and water in the gutter 20 can then be filtered to separate the debris from the water, with the water being recycled back into the apparatus, and the debris being stored for use or disposal. The above arrangement rests on a frame 22.

In use, the separation channel 14 is filled with water, and contaminated aggregate or any other combination of solid materials of different weights is deposited into the upper end of entry chute 12. The combined solid materials are driven down the entry chute 12 under the action of water jets 24 into the body of the water, and into the separation channel 14. The combined solid materials are then driven along the separation channel 14 under the action of water jets 26, generally along the base of the channel 14. The base of the channel 14 is provided with an agitation surface (not clearly visible in FIG. 1) which is provided with formations against which the water jets 26 agitate the combined material to separate it, and over which the combined material is urged from the end of the channel 14 adjacent to the entry chute 12 to the end of the channel 14 adjacent to the exit chute 16. As the combined material progresses over the agitation surface, it tends to separate due to the force of the water, and the violent and forceful rubbing action between particles of aggregate. Where relatively heavier and lighter materials separate, the heavier materials (e.g. glass cullet) tend to continue along the base of the channel while the lighter materials (e.g. plastics, food waste and paper) tend to rise to the surface of the water, where they may float until they exit the channel 14 over the rim 18 and into the gutter 20.

In order to aid this process, debris guides 30 are provided at the surface of the water within the separation channel 14. Such debris guides may be preferred, it will be appreciated that they are not essential to the operation of the apparatus presented in this application. As can be seen in FIG. 1, these guides 30 are “V” shaped. In the FIG. 1 embodiment, the direction and force of the water jets 26, and the shape of the formations of the agitation surface are such that the prevailing direction of flow of water at or near the top (surface) of the channel is opposite to the direction in which the aggregate is moved along the bottom (base) of the channel. As a result, the V shaped guides are oriented “pointing” against the direction of surface flow, so that the water, and any debris carried by that water, is diverted sideways towards (and thus over) the rims 18 and into the gutters 20 at each side of the channel 14. While in principle a rim 18 and gutter 20 could be provided only at one side of the channel, with the guide 30 being slanted across the surface of the channel to divert water and debris towards that side, this would mean that some of the debris (that at the side opposite to the rim 18 and gutter 20) would have twice as far to travel to reach the edge. The apparatus is therefore able to remove debris from the surface of the water much more quickly if a rim 18 and gutter 20 are provided to both sides of the channel 14. The debris guide 30 extends below the surface of the water, so that debris near but not at the surface is guided towards the edges, and is also angled so that this debris will climb the slant of the debris guide 30 to reach the surface of the water. The debris guide 30 also extends above the surface of the water so that water (and debris) does not flow over the top of it. It will be appreciated that the flow of the water will tend to cause the water itself to climb up and over the debris guide 30, and to inhibit this a lip is provided at the top of the debris guide 30 which extends back over the inbound water flow. The cleaned aggregate (heavier solid materials) which has been urged along the bottom of the channel 14 eventually reaches the base of the exit chute 16, and is then urged up the exit chute under the action of water jets 28, and exits over the edge. It will be appreciated that aggregate is therefore progressing from the right hand side of FIG. 1 to the left hand side of FIG. 1, while the surface water is generally progressing from the left hand side of FIG. 1 to the right hand side of FIG. 1.

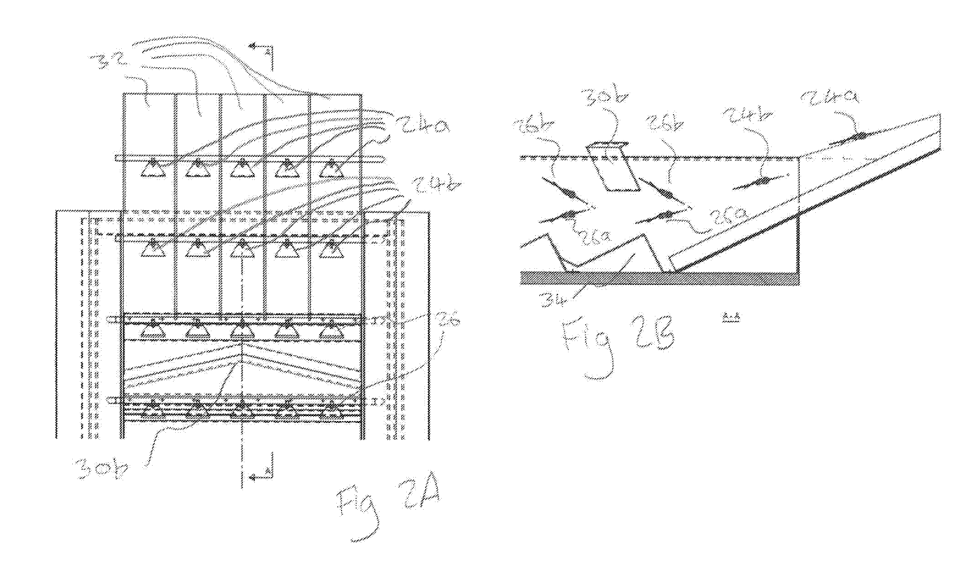

Referring to FIG. 2A (plan view), the entry chute 12 can be seen to be divided into a number of partitions 32, which provides for the aggregate to flow more evenly down the entry chute 12. In use, aggregate is deposited at the top of the partitions 32 (at the top of FIG. 2A). The water jets 24 can be seen to comprise a nozzle and a deflection plate. The deflection plates shape and deflect the stream of water from the nozzles into a desired shape and direction (deflection plates will be described in further detail below). Two banks of water jets 24a and 24b are shown in FIG. 2A which urge the aggregate down the entry chute 12 and into the channel 14, as well as two banks of the water jets 26 within the separation channel 14, which effectively take over from the water jets 24a and 24b in driving the aggregate forwards when it reaches the separation channel 14. Unlike the separation channel, which comprises a non-planar agitation surface, the base of the entry chute 12 is smooth, to reduce the accumulation of aggregate. It will be appreciated that some separation of the aggregate may occur within the entry chute 12 due to the force of the water jets 24a and 24b and the rubbing of aggregate against itself, but that without an agitation surface against which the aggregate can be agitated the degree of separation occurring within the entry chute 12 is likely to be low.

Referring to FIG. 2B (side view—section through line A-A of FIG. 2A), the jets 24a, 24b can be seen towards the top (24a) and middle (24b) of the entry chute 12. The base of the entry chute 12 can be seen to be on an angle, so that gravity helps to carry incoming aggregate from the top to the bottom of the entry chute 12, assisted by the action of the jets 24a, 24b. It can be seen from FIG. 2B that the entry chute 12 starts outside of but extends down into the channel 14. Moreover, the water level in the channel 14 is such that the surface of the water extends across most of the entrance chute 12 as well. As a result, only the jets 24a are above the water level, with jets 24b being below the surface of the water. As well as assisting in driving the aggregate down the entry chute 12, the jets 24a, 24b (and most particularly the jets 24b) also drive the aggregate against, up and over a first formation 34 of the agitation surface at the base of the channel 14. It will be noted in FIG. 2B that the channel 14 comprises water jets 26 in two banks—upper banks 26b and lower banks 26a. The lower bank of jets 26a serves to move and agitate the aggregate over and against the formations of the agitation surface, while the upper bank of jets 26b serves to direct the lighter material (e.g. debris) released from the aggregate upwards towards the water surface and/or towards the guides 30b. As a result, the flow of water at and near the water surface is in FIG. 2B is the same direction as the direction in which the aggregate is urged (i.e. the opposite direction to in FIG. 1), and thus debris guides 30b are oriented in the opposite direction in FIGS. 2A and 2B than when compared with FIG. 1.

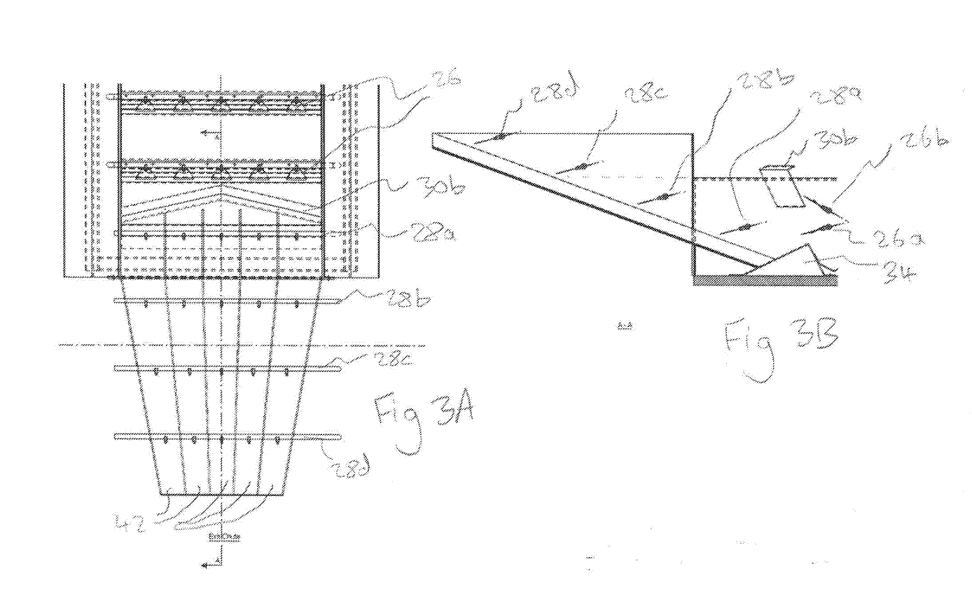

Referring to FIG. 3A (plan view), the exit chute 16 can be seen to be divided into a number of partitions 42, which provides for the aggregate to flow more evenly up the exit chute 16. In contrast to the water jets 24 and 26, the water jets 28 can be seen to comprise only a nozzle and to lack a deflection plate. This is because the water jets 28 do not need to agitate the aggregate against shaped formations, but merely need to urge it up and out of the exit chute 16, and to wash away any loose debris or contaminant as the aggregate progresses out of the water and towards the exit edge of the exit chute 16. Four banks of water jets 28a, 28b, 28c, 28d are shown in FIG. 3A, as well as two banks of the water jets 26 within the separation channel 14, from which the water jets 28a effectively take over in driving the aggregate forwards towards the exit when it has completed its passage through the separation channel 14. Unlike the separation channel 14, which comprises a non-planar agitation surface, the base of the exit chute 16 is smooth, so that cleaned aggregate can be moved smoothly up and out of the exit chute 16.

Referring to FIG. 3B (side view—section through line A-A of FIG. 3A), the jets 28a, 28b, 28c, 28d can be seen at various positions along and above the base of the exit chute 16. The base of the exit chute 16 can be seen to be on an angle, so that the aggregate is carried out of the body of water in the channel 14 before exiting the apparatus. The jets 28a, 28b, 28c, 28d are required to push the cleaned aggregate (heavier materials) up and out of the exit chute 16 against gravity. It can be seen from FIG. 3B that the entry chute 16 ends outside of but starts down within the channel 14. Moreover, the water level in the channel 14 is such that the surface of the water extends across most of the exit chute 16 as well. As a result, the jets 28a, 28b, 28c, 28d are only required to carry the cleaned aggregate a short distance above the surface of the water. It will be appreciated that the aggregate weighs less within the water than outside it, with the result that it is easier to move the aggregate when it is in the water. It can also be seen from FIG. 3B that the water jets 28a and 28b are below the surface of the water, 28c is approximately at the water surface, and 28d is well above the surface of the water, to give the aggregate a final push over the edge of the exit chute 16. Only the jet 28d is required to shift aggregate which is unsupported by water, and this only for a short distance. It will be noted in FIG. 3B that the channel 14 comprises water jets 26 in two banks—upper banks 26b and lower banks 26a. The lower bank of jets 26a serves to move and agitate the aggregate over and against the formations of the agitation surface, while the upper bank of jets 26b serves to direct the lighter material (e.g. debris) released from the aggregate upwards towards the water surface. As a result, the flow of water at and near the water surface is in FIG. 3B in the same direction as the direction in which the aggregate is urged (i.e. the opposite direction to in FIG. 1), and thus debris guides 30b are oriented in the opposite direction.

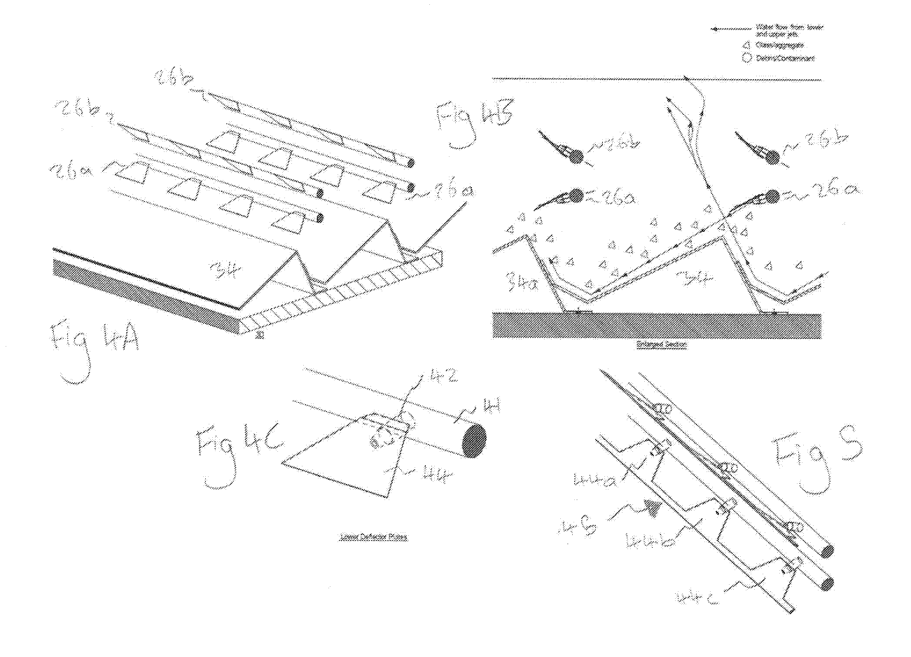

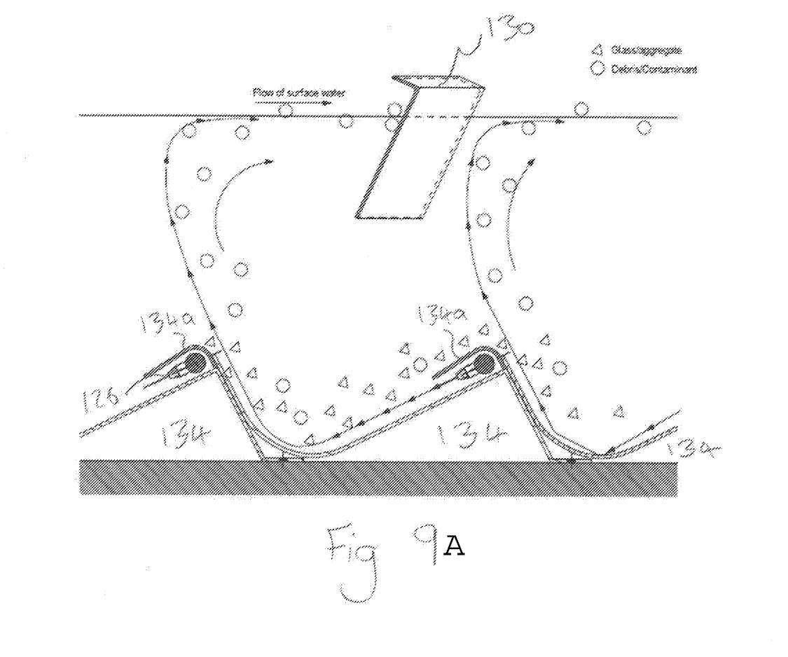

Referring to FIG. 4A, a 3D view of a portion of the inside of the channel 14 is shown. The inside of the channel 14 can be seen to comprise an agitation surface at its base, comprising a series of formations 34, over which aggregate is to be conveyed, and against which the aggregate is to be agitated. In the present case each formation 34 extends as a ridge across the full width of the base of the channel 14, but it will be appreciated that different arrangements are possible. Above and slightly behind each of the formations 34, a lower bank of water jets 26a and an upper bank of water jets 26b are provided. The lower bank of water jets 26a drive the aggregate/heavier solid materials along the base of the channel 14 over and against the agitation surface. The upper bank of water jets 26b are directed towards the surface of the water, and carry debris/lighter materials up to the surface where they exit over the sides of the channel 14. Typically, a bank of water jets is provided above and behind each formation of the agitation surface. The lower bank of water jets 26a is directed substantially down and along a descending (rear) surface of the formation 34. Where both upper and lower banks of jets are used and are oriented in a forwards direction, the prevailing flow direction at the water surface is typically the same direction as the aggregate is being urged. If only the lower bank of jets is provided (as is the case in FIG. 1 for example, and in FIG. 8 described below), or if the upper bank of jets faces in a reverse direction, then the prevailing flow direction at the water surface may be opposite to the direction in which the aggregate is being urged. It should be understood that the prevailing flow direction at the surface may not only be a function of the jets, but also of the shape and size of the formations, and the overall dimensions of the channel 14.

Referring to FIG. 4B, a side view of a formation 34 and upper and lower banks of water jets 26a, 26b is shown, relative to the surface 40 of the water. In FIG. 4B, the triangles indicate the positions of the glass/aggregate within the channel, demonstrating that in general these heavier components remain near the bottom of the channel as they are carried along by the jets 26a and the general current near the base of the channel 11. The arrows emanating from the water jets 26a indicate the direction of the streams of water output from the water jets 26a. It can be seen that the direction of the streams deviates from the axis of the nozzles due to the presence of the deflection plate. The stream of water from the water jets 24a pushes the aggregate down and along a descending (rear) surface of the formation 34, and then up an ascending (front) surface of an adjacent formation 34a, where it then enters the jet stream of the next bank of jets. Towards the right of FIG. 4B, the arrows indicate the flow direction of water promoted by the previous bank of lower jets (not shown in FIG. 4B, off to the right hand side of the jets shown in FIG. 4B). It can be seen that the water tends to continue to flow upwards in generally the direction set by the angle of ascent of the front (ascending) face of the formation 34, carrying with it any debris released from the aggregate by its agitation. This flow will tend to carry the debris to the water surface, where it is guided to and over the rim 18 and into the gutter 20. However, the heavier materials are too heavy to be driven to the surface by the upwards flowing currents, and therefore drop down over the apex (peak) of the next projection.

The more powerful the streams of fluid projected by the underwater jets 26, the greater the water impact against the aggregate and the more debris is removed. The angle of the underwater jets 26 is arranged so as to allow both agitation of the aggregate and also to allow flow of the aggregate to progress through the channel to the exit chute 16. Generally, the bottom banks of jets 26a should be angled so that the streams of water are substantially parallel to the descending surfaces of the formations, or strike the descending surfaces at a shallow angle.

The agitation surface in the base of the channel comprises formations which are shaped and dimensioned to promote agitation and abrasion of the aggregate. The location, shape and size of the formations are selected so that jets 26a direct pieces of aggregate against the formations so that pieces of aggregate collide with one another and agitate or abrade one another, enhancing the removal of debris, such as paper and unwanted waste material. The relatively shallow descending surface of the formations provides an extended area over which the aggregate can progress under the action of the water jets. While the aggregate is progressing along the descending surface pieces of the aggregate tumble over and against each other and against the hard surface of the formation, tending to remove debris. The shallow angle is also important because it lessens the angle with which the descending surface meets the ascending surface of the next formation—if the joining angle is too great then debris has a tendency to build up in this area, and the stream of water from the jets will tend to collapse upon impact with the base of the ascending surface rather than to be redirected to climb the ascending surface. However, the shallow angle results in the debris remaining close to the aggregate near the bottom of the channel. The ascending surface, which the aggregate and debris reaches when it has descending to the base of the descending surface, provides a much steeper ascent. As well as promoting a different form of agitation under the action of the water jets, the path of ascent upwards at a steep angle results in different paths through the liquid in the channel being taken by the heavier materials and the lighter materials. In particular, the lighter materials tend to continue the line of ascent from the ascending surface up towards the top of the channel and the surface of the liquid, while the heavier materials tend to drop over the apex and onto the descending surface of the next formation (where they are captured by the next set of water jets) under their own weight. It will therefore be appreciated that it is desirable that the formations have an ascending surface which is steeper than its descending surface.

There is a balance to be struck and maintained between achieving controlled water flows which reliably carry the aggregate forwards and the debris to the surface, a high degree of local turbulence near the formations in order to agitate and separate the aggregate, and providing the relatively tranquil conditions of the surface of the water in the trough, such that debris can be skimmed off the surface by way of controlled flow over the rim. The surface current should be sufficient to transport debris and less dense materials into the gutter, whilst the subsurface current should be locally very vigorous near the base of the channel to promote abrasion and cleaning of the aggregate. The formations can be installed at a variety of angles, depending of the type of aggregate to be cleaned, and the angles and power of the water jets. It will be understood that the agitation surface presents a ‘washboard’ surface that helps speed up cleaning (by promoting agitation) and/or retain aggregate in the channel for a longer time period, due to the greater distance to be travelled by the aggregate, and the slowing effect of the ascending surfaces.

As can be seen from FIGS. 4A and 4B, the apparatus may comprises a first bank of jets arranged to direct pressurised liquid at the contaminated aggregate in order to agitate the contaminated aggregate against a surface thereby promoting separation of cleaned aggregate. The first bank of jets 26a is arranged in a predominantly downward direction so that the jets are directed towards the bottom of the channel 14 in order to agitate the aggregate. In the case of FIGS. 4A and 4B, the apparatus further comprises a second bank of jets 26b arranged to direct and/or urge the debris in an upward direction towards the surface of the water. In contrast, FIG. 1 shows an apparatus in which only downward facing jets are provided, with upward motion of debris being achieved by way of the shape of the formations at the base of the channel 14. The first bank of jets 26a are arranged within an array comprising a plurality of spaced apart rows of first jets. The jets within each row are arranged to be spaced apart from each other from a first side of the trough to a second opposed side of the trough. The jets within each row are spaced apart from each other in a direction extending transverse to, for example substantially perpendicular to, the length of the channel 14. The first jets within each row are in fluid communication with a a manifold extending between the pair of opposed sides of the trough. A pump provides a constant pressure of a liquid (although in some embodiments a gas, such as air, may be used instead), such as water, using needle valves or isolation valves, depending on the aggregate being cleaned. Each manifold may have a fluid dynamic water pressure of between 50-300 psi (3.34-20.69 bar), this may be increased depending on the aggregate being cleaned. Each jet, ideally, when steady state conditions are met, has a constant dynamic flow and pressure, to enable accurate and constant flow rate of liquid, such as water to force the contaminated aggregate through the channel 14 in a forwards direction from the entry chute 12 to the exit chute 16.

Both the lower and upper jets 26a, 26b may be arranged to be rotatable about an axis extending transverse to the length of the channel 14. One or more, for example each, of the jets may be rotatable about the longitudinal axis of the manifold. The jets within each row may be collectively rotatable about the longitudinal axis of the manifold. Alternatively, each jet within each row may be arranged to be individually rotatable about the longitudinal axis of the manifold. The angle of each jet within the row, or of all the jets within the row, may be selectively varied in order to alter the angle with which the stream of water impinges the flow of liquid within the channel 14. Each row of jets within each of the arrays is spaced apart from an adjacent row of corresponding jets along the length of the channel 14. As shown in FIG. 4A, each upper bank of jets 26b is displaced in a more upward direction from the corresponding lower bank of jets 26a. The upper bank of jets 26b may be aligned with the lower bank of jets 26a.

FIG. 4C shows an expanded view of a water jet comprising a nozzle 42 projecting from a manifold 41 and a deflection plate 44. Water is pumped to the nozzle (and adjacent nozzles) through the manifold 41. The water is then expelled out through the nozzle 42 in a stream which strikes the bottom side of the deflection plate 44. The deflection plate 44 is mounted just above the nozzle 42, but is angled to intercept the stream of water projected from the nozzle 42. From any of FIGS. 1 to 3 it can be seen that any one water jet 26 is required to act on aggregate across a certain proportion of the width of the channel 14. However, as can be seen from FIG. 4B it is desirable for the jet to be very focused in the vertical direction in order to maximise the force with which the jet strikes the aggregate—required both to be sufficient to move the aggregate along and up the ascending face of a formation (which is a substantial distance from the water jets 26a), and also to promote sufficient agitation of the aggregate to separate the debris from the aggregate. While fan nozzles can provide this geometry to some degree, it has been found that by directing the (preferably already fan shaped) stream at a planar surface (the deflection plate) it is possible to increase the lateral extent (across the width of the channel) of the stream while retaining a narrow vertical extent. This uses the existing water pressure and flow rate most effectively. In addition, the deflector plate 44 protects the stream of water from being broken up by the upward current rising from the ascending surface directly underneath the water jets.

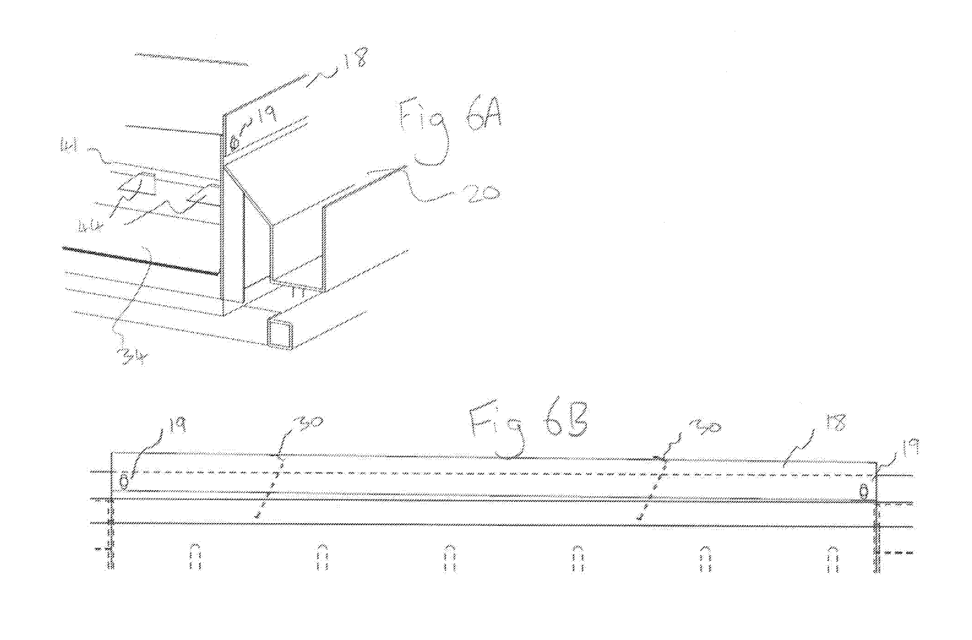

Referring to FIG. 5, a single-part deflector 45 is shown comprising a series of deflector plates 44a, 44b, 44c disposed over respective nozzles of a manifold. The single-part deflector can be manufactured and fitted more cheaply than individual deflectors, requiring fixing only to either side of the channel, rather than to the manifold itself. This arrangement also makes it much easier to provide adjustability. In particular, if the fixing at each side of the channel is an adjustable fixing, the angle of the deflector plates 44a, 44b, 44c can be adjusted to the same pitch, at the same time, simply by adjusting the pitch of the single-part deflector 45 as a whole. FIG. 5 also shows an upper manifold, upper nozzles and upper deflector, which are each similar in structure to the lower manifold, lower nozzles and lower deflector. In some cases, the debris guides may act as a deflector to redirect and shape streams of fluid emitted from some of the upper jet nozzles (noting that debris guides need not be provided adjacent each bank of jet nozzles) to form the streams of fluid directed towards the surface of the liquid. Where implemented, this reduces the number of dedicated upper deflectors which are required.

Referring to FIG. 6A, a 3D view of a portion of the channel 14 is shown. One of the manifolds 41 and its deflector plates 44 are visible, as is a formation 34 below it. Part of the rim 18 is also visible, with adjustability being provided by an adjustment bolt and slot 19. In some embodiments the rim 18 may be provided in several lengths, with each length being independently adjustable for height. The gutter 20 is also shown, provided outside of the channel, and being positioned to catch any water and debris which escapes over the rim 18. An external side view of the upper edge of the channel 14, including the rim 18, is shown in FIG. 6B. It can be seen from FIG. 6B that the rim is raised higher towards the left hand side of the diagram than at the right hand side (notice the position of the upper edge of the rim 18 relative to the debris barriers 30). The reason for this is that the fluid flows within the channel 14 tend to result in the water surface not being level, but instead being at a slight incline with respect to the horizontal, with the degree of incline being proportional to (among other things) the flow rate of water through the apparatus. It is desirable that water and debris be permitted to escape over the rim 18 substantially uniformly along the length of the channel 14. Accordingly, it is undesirable for the water surface to be below the upper edge of the rim (such that the water cannot escape) or a long way above the upper edge of the rim (which will cause a very high flow rate of water exiting the channel, which is inefficient). By providing an adjustable rim, it is possible to achieve uniform debris removal from the surface of the water along the full length of the channel, even when the operating conditions of the apparatus are changed in a manner which alters the incline of the water surface.

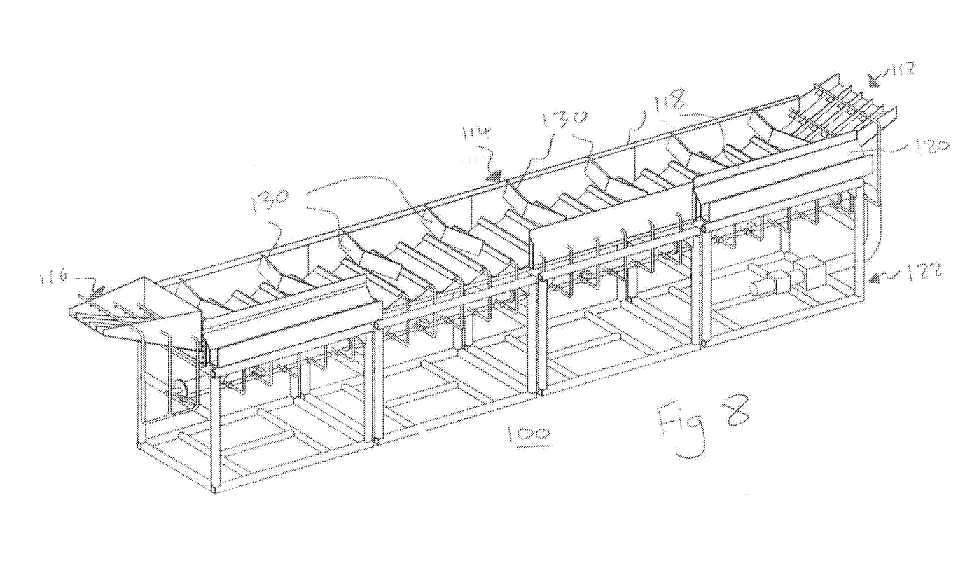

Referring to FIG. 7A, the positioning of a debris guide 30 with respect to formations 34 and lower and upper jets 26a, 26b is shown. It will be appreciated that debris guides 30 need not be provided at the same distance interval along the length of the channel as the formations and water jets, and will typically be provided less frequently. In FIG. 7A, upper water jets 26b are provided and thus the water flow at or near the surface of the water is forwards (in the same direction as the aggregate is being urged by the lower water jets 26a). The debris guide 30 is therefore oriented such that the flow of water from the water jets 26b is diverted outwards towards the sides of the channel 14 upon striking the debris guide 30. FIG. 7B provide a side view of the formations 34, the lower jets 26a, the upper jets 26b and the debris guide 30. The circles represent the position of debris/contaminant/lighter material within the channel 14. The upper and lower jets and the formations are substantially as per FIG. 4B. In contrast with FIG. 4B (which demonstrated the position of the aggregate/heavier material near the bottom of the channel) it can be seen that the debris is generally carried by the flow of the water up the ascending (front) surface of the formation 34 and then continues generally along the same line of ascent to be captured by the stream of water from the upper jets 26b and thus forced against the debris guide 30 to be diverted to and over the rim 18 into the gutter 20.

FIG. 8 schematically illustrates another embodiment, in which the water jets are effectively integrated into the agitation surface. FIG. 8 shows a separation apparatus 100 as a whole, including entry 112 and exit 116 chutes which are substantially as described above. Similarly, the apparatus is supported on a frame 122, and a rim 118 and gutter 120 extend along either side of the apparatus. These elements are not described again, since their structure and operation is precisely as explained above. In FIG. 8, a side panel, rim and guttering have been omitted from the drawing to provide a view of the structure inside a separation channel 114. It can be seen that debris guides 130 in this case are oriented for reverse surface flow (i.e. the water at or near the surface is flowing in the opposite direction to the direction in which the aggregate is being conveyed). This is at least partly due to the absence of upper jets in this design. As a general point is has been found to be desirable that the surface water, which is relatively heavy with debris and contaminant, moves away from the exit chute 116 of the apparatus, since the aggregate exiting the apparatus can thus be expected to be cleaner than if the surface water were to be moving towards the exit chute 116.

It can be seen in FIG. 8 that the water jet manifolds each pass under an apex of the formations, with the formations extending over the manifolds with a hood or cover portion. As a result, the body of water above the formations is free of water jet manifolds which might otherwise provide an obstruction to debris travelling to the surface, and which may interfere with desired flows within the body of water within the channel. With this implementation, a generally less turbulent and more uniform flow can be expected within the main body of the water, making it more likely that debris will be carried to the surface.

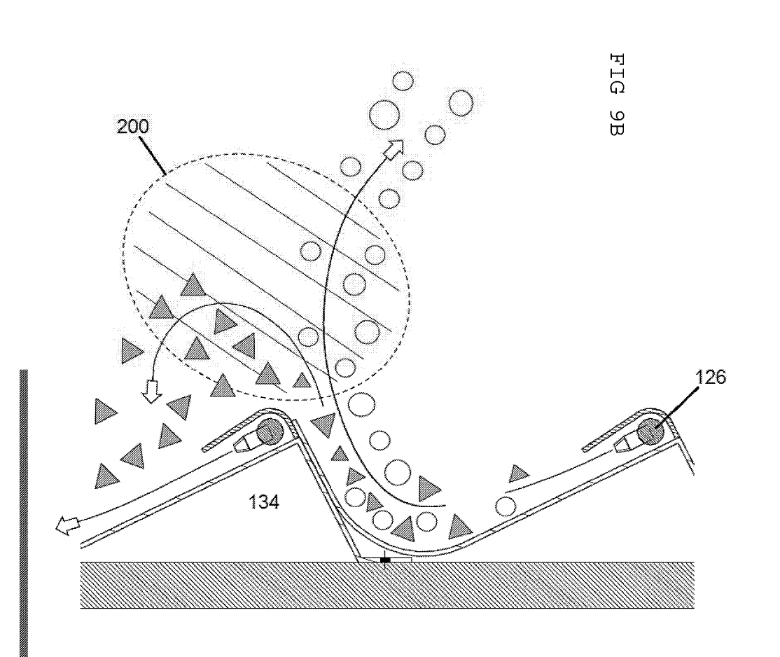

FIG. 9A is a side view of the formations, water jets and debris guide. FIG. 9A shows the positions of both the heavier material (glass or aggregate for example) with small triangles and the lighter material (debris or contaminant for example) with small circles. In FIG. 9A, formations 134 comprise an upper portion 134a under which water jets 126 (nozzle manifold) is positioned, and part of which forms the apex of the formations. The ascending surface (front face) of the formation 134 extends from the base up to the apex. The descending surface (rear face) of the formation 134 comprises an upper part under which the water jets (nozzle manifold) is provided, a lower part which extends to the base of an adjacent formation, and an opening from the covered area in which the water jets 126 are provided, via which the nozzles direct streams of water down along the lower part of the descending surface of the formation 134. The streams of water from the jets 126 pushes both the aggregate and debris down the lower part of the descending surface, to then rise up the ascending surface of the adjacent formation. The aggregate, being heavier, continues its forward motion over the apex of the adjacent formation and down the upper (cover) part of the descending surface of the formation, to drop in front of the path of the stream of water projecting from under the cover. In this way the aggregate is urged from one end of the separation channel to the other. In contrast, the debris, being lighter, is carried up towards the surface of the water as shown, approximately continuing the direction and path set by the ascending surface. At or near the surface of the water, its direction reverses to travel towards the entrance chute 112 of the apparatus 100. When the debris strikes the guide 130 it is diverted to and over the side of the channel 114 into the gutter 120.

FIG. 9B is a side view of the formations and water jets. FIG. 9B shows the positions of the heavier material with triangles and the lighter material with circles. In FIG. 9B, the turbulent zone in the fluid 200 created by the formation 134 is depicted. In this turbulent zone, the heavier material may be separated from the lighter material due to the different behaviours of both the heavier and lighter materials in the turbulent flow. FIG. 9B depicts the lighter material being carried towards the surface of the fluid by the flow from the water jets 126, whilst the heavier material is carried over the formation 134 by the same fluid flow, the separation between the heavier and lighter materials occurring in the turbulent zone 200.

The differences in behaviour between the heavier and lighter fluid flows may also be observed due to the differences in density between the two materials, or differences in the average shape of the heavier and lighter materials. In the case of an aggregate of glass cullet and plastic, the pieces of glass cullet may, on average, be generally curved or non-planar whilst the plastics may, on average, be larger and with a more planar profile. This difference in shape may occur due to the objects from which the aggregate originates; for example, generally curved pieces of glass cullet may originate from broken bottles or glasses whilst dense, planar plastics may originate from protective covers or sheets. These differences in shape between the differing sources of material in the aggregate result in different behaviours in the area of turbulent flow, the flatter plastic sinking more slowly and with a wider horizontal dispersion.

The separation of debris from glass cullet is one of many potential uses for the aggregate cleaning apparatus. Alternatively, the aggregate cleaning apparatus may be used to separate an aggregate of biofuel and grit, dirt or other contaminants. In this embodiment of the invention, the influence of the means of directing fluid at the aggregate, along with the agitation surface, may encourage the removal of contaminants from the biofuel. In one such example, fibrous, organic, biofuel or biofuel precursor material rises to the surface of the fluid contained in the channel under the influence of the fluid flow. Concurrently, heavier pieces of grit or stone, contaminants in the biofuel or biofuel precursor material, are pushed along the base of the channel, passing over any agitation surfaces, until they are also removed from the channel.

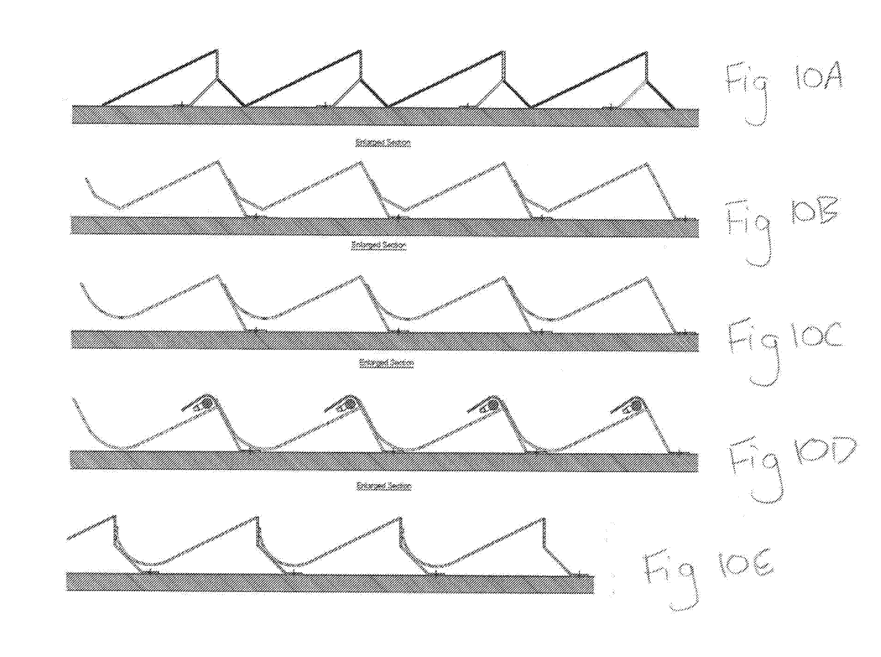

FIGS. 10A to 10E show five different shapes for the formations of the agitation surface. FIG. 10A shows a formation in which the ascending surface comprises two parts; a first shallow part (at an angle of approximately 45° with respect to the base of the channel) and a second upright part. The descending surface is a single part, and extends from the apex (top of the second upright part of the ascending surface) down to the base of the first shallow part of the next formation. The shallower first part of the formation allows aggregate to be pushed up it under the action of the water jets, while the upright part imparts an upwards direction to the flow which carries the lighter material/debris to the surface of the water.

FIG. 10B shows a similar formation to FIG. 10A, but with a first shallow part which is at an event shallower angle than in FIG. 10A (approximately 30°), in order to make it easier for the jets to urge the aggregate up the slope, and a second part which is not upright, but is at a steeper angle than the first shallow part (approximately 60°), retaining an upward direction to the debris-carrying flow but with a less retarding effect on the forward motion of the heavier aggregate.

FIG. 10C shows a formation which is similar to FIG. 10B, but which has a curved, convex, transition from the descending surface, through the base of the ascending surface, and up to part way along the ascending surface. Effectively, the inclination of the ascending surface gradually increases from its base up until part way up the ascending surface. This curved design provides for a smoother flow of water, aggregate and debris, and may be less prone to wear.

FIG. 10D shows a formation in which the water jets are integral with the formation, as also shown in FIGS. 8 and 9. It can be seen from FIG. 10D that both the apex and the base parts of the formations are curved, and that the upper part of the formation houses the water jets, which are able to project down the descending surface via an aperture in the descending surface.

FIG. 10E shows a formation which is similar to FIG. 10A, but in which a curved, convex, transition is provided from the descending surface, through the base of the ascending surface, and up to part way along the ascending surface, in like manner to FIG. 10C.

It will be appreciated that in all of the above cases at least part, and preferably all or most of the ascending surface is at a greater inclination with respect to the base than the descending surface.

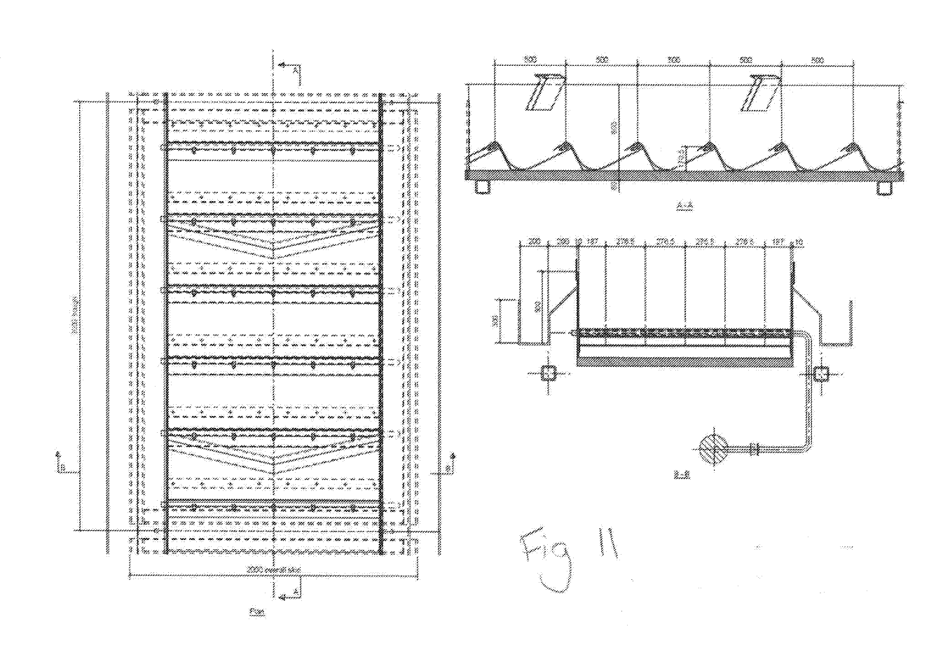

Referring to FIG. 11, a plan view (left), a cross section along the length of the channel (upper right) and a cross section across the width of the channel (lower right) are set out. Example dimensions for the apparatus are set out, but are intended to give a sense of scale for exemplary purposes, and are not intended to limit the scope of the invention. In the present example, the apparatus is shown to have a 3000 mm trough, with formation peaks (and thus also the jets in adjacent rows) separated by 500 mm. Five nozzles are provided on a single manifold, separated by 276.5 mm. The height of the nozzles above the base of the channel is 170.5 mm.

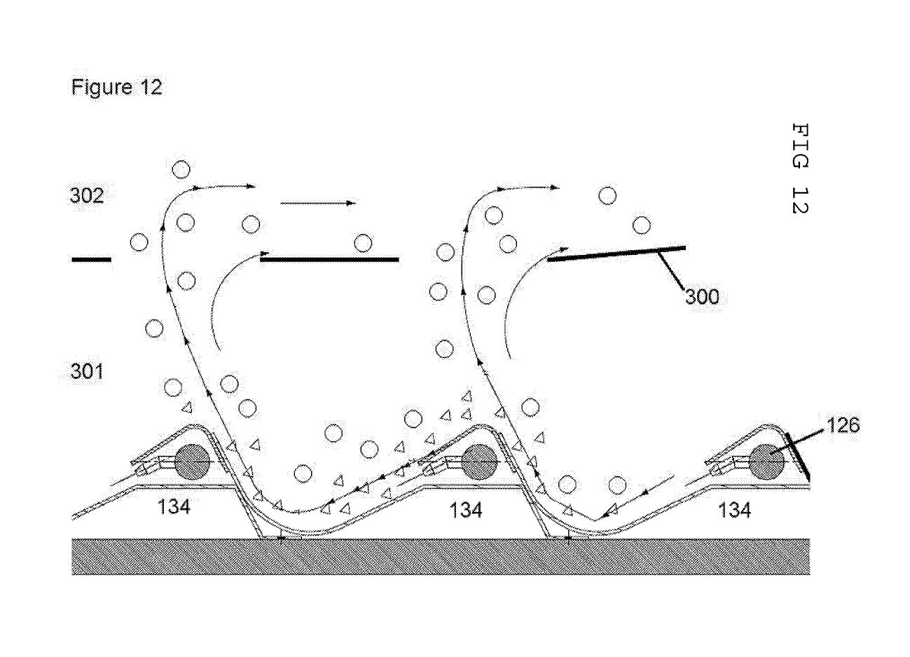

FIG. 12 depicts an embodiment of the invention where the cleaning apparatus further comprises a plurality of flow dividers or hydrofoils 300 positioned horizontally across the channel 114. In this embodiment, said flow dividers may separate the turbulent flow in the lower regions of the channel 301, from the reverse, less turbulent flow in the upper regions of the channel 302 to assist in the removal of lighter debris from the channel.

Additionally, said flow dividers 300 may be rotated perpendicular to the longitudinal axis of the channel 114 or moved along the longitudinal axis of the channel 114 such that they are positioned to separate the turbulent lower flow 301 and less turbulent upper flow 302 most effectively.

Additionally, said flow dividers 300 may be overlapped.

The invention has been described by way of examples only and it will be appreciated that variation may be made to the above-mentioned embodiments without departing from the scope of invention. For example, the jets may provide any suitable fluid, such as for example pressurised gas, so as to provide for example an air knife directed towards the liquid within the channel(s).

1. An apparatus for separating solid materials, the apparatus comprising:
a channel for receiving a liquid and the materials to be separated, the channel being provided with an agitation surface;
means for directing streams of fluid at the materials to be separated, the streams of fluid urging the materials over and against the agitation surface to separate the materials;
wherein heavier material is urged along the bottom of the channel to an exit under the action of the streams of fluid, and lighter material separated from the heavier material rises to the surface of the liquid; and
wherein the agitation surface comprises a plurality of formations each extending across at least a portion of the width of the channel, each formation comprising an ascending surface and a descending surface, at least part of the ascending surface having a steeper slope with respect to the base of the channel than the descending surface.

2. The apparatus according to claim 1, wherein the ascending surface comprises a first ascending part at a first angle with respect to the base of the channel and a second ascending part at a second angle with respect to the base of the channel, the first angle being shallower than the second angle, wherein at least some of the streams of fluid are directed approximately towards the first ascending part.

3. The apparatus according to claim 1, wherein the descending surface extends from an apex of the ascending surface to the base of the ascending surface of an adjacent formation.

4. The apparatus according to claim 3, wherein at least some of the streams of fluid are directed approximately parallel with or at a shallow angle down onto the descending surface.

5. The apparatus according to claim 2, wherein the second ascending surface is substantially upright.

6. The apparatus according to claim 1, wherein at least part of the ascending surface and/or descending surface is curved and/or concave.

7. The apparatus according to claim 1, wherein the means for directing comprises a bank of jet nozzles provided at spaced intervals across the width of the channel, and a deflector extending across the channel in front of the bank of jet nozzles for redirecting and shaping streams of fluid emitted from the jet nozzles to form the streams of fluid directed towards the materials.

8. The apparatus according to claim 7, wherein the deflector is adjustably attached at either side of the channel and comprises a deflector plate positioned in front of each of the jet nozzles.

9. The apparatus according to claim 1, wherein the channel is provided with an adjustable rim along the upper edge of at least one side of the channel

10. The apparatus according to claim 9, wherein the inclination of the rim with respect to the channel is adjustable.

11. An The apparatus according to claim 9, wherein an adjustable rim is provided along both sides of the channel.

12. The apparatus according to claim 9, wherein the surface of the liquid in the channel is substantially parallel with the upper edge of the rim.

13. The apparatus according to claim 9, comprising a gutter which extends along the outside of the channel, to receive liquid escaping from the channel over the rim.

14. The apparatus according to claim 13, wherein the channel is provided with one or more guides at the liquid surface, the guides being shaped to direct separated lighter material at or near the surface of the liquid towards and over the rim and into the gutter.

15. The apparatus according to claim 14, comprising means for directing fluid towards the guides and/or the surface of the liquid.

16. The apparatus according claim 15, wherein the guides act as a deflector to redirect and shape streams of fluid emitted from jet nozzles to form the streams of fluid directed towards the surface of the liquid.

17. The apparatus according to claim 14, wherein the debris guide extends below the surface of the liquid, and is sloped such that a prevailing flow of the liquid near the liquid surface pushes the separated lighter material within the liquid against and up the slope of the guide towards the liquid surface.

18. The apparatus according to claim 17, wherein the debris guide extends above the surface of the liquid.

19. The apparatus according to claim 1, wherein when the apparatus is in use, the prevailing direction of the surface current at the top of the channel is substantially opposite to the direction of travel of the heavier material along the bottom of the channel.

20. The apparatus according to claim 1, wherein the means for directing is integral with and/or part of the agitation surface.

21. The apparatus according to claim 1, wherein the means for directing is positioned underneath the apex of a formation.

22. The apparatus according to claim 21, wherein a first, upper, part of the descending surface is defined by the top of a cover under which the means for directing is located, the means for directing being configured to direct the streams of fluid down and along a second, lower part of the descending surface towards the base of the ascending surface of an adjacent formation.

23. The apparatus according to claim 1, wherein the ascending surface and/or descending surface have a shallower gradient at or near the base and/or the apex than half way along.

24. The apparatus according to claim 1, wherein the heavier material is an aggregate such as glass cullet, and the lighter material is debris.

25. The apparatus according to claim 1, wherein the heavier material is a contaminant, and the lighter material is a biofuel.

26. The apparatus according to claim 1, wherein the heavier material is a contaminant, and the lighter material is a biofuel precursor.

27. The apparatus according to claim 1, wherein a portion of the lighter material is denser than the fluid.

28. The apparatus according to claim 1, wherein a turbulent zone is formed in the fluid proximal to the agitation surface.

29. An The apparatus according to claim 28, wherein the turbulent zone assists the separation of the heavier and lighter material.

30. The apparatus according to claim 29, wherein differences between the average shape of the heavier material and the average shape of the lighter material assists the separation of said materials in the turbulent zone.

31. The apparatus according to claim 1, wherein the apparatus further comprises at least one flow divider.

32. The apparatus according to claim 31, wherein said flow divider is located proximal to the surface of the fluid.

33. The apparatus according to claim 31, wherein said flow divider may be rotated.

34. The apparatus according to claim 31, wherein said flow divider may be moved along the longitudinal axis of the channel.

35. The apparatus according to claim 1, wherein the liquid and the fluid are both water.

36. (canceled)
